(19) United States
(12) Patent Application Publication
(10) Pub. No.: US 2021/0150651 A1
(43) Pub. Date: May 20, 2021

(54) PROPERTY AND NEIGHBORHOOD ASSESSMENT SYSTEM AND METHOD

(71) Applicant: Matthew G. Shoup, Novato, CA (US)

(72) Inventor: Matthew G. Shoup, Novato, CA (US)

(21) Appl. No.: 16/952,722

(22) Filed: Nov. 19, 2020

Related U.S. Application Data
(60) Provisional application No. 62/937,598, filed on Nov. 19, 2019.

(51) Int. Cl. G06Q 50/16; G06F 16/909; G06F 16/9038; G06N 20/00; G06F 17/18

(52) U.S. Cl. CPC G06Q 50/163; G06F 16/909; G06F 17/18; G06N 20/00; G06F 16/9038

(57) ABSTRACT

A real estate property safety assessment system and method are provided. The system may (i) input safety information from various third-party sources relating to a particular property (e.g., crimes committed within different proximities to the property, types of crimes, dates of crimes, etc.), (ii) convert the safety information into standardized formats for processing and sharing, (iii) process the safety information to determine crime severity ratings, and (iv) process the various crime severity ratings to determine one or more safety ratings for the property of interest. The system may then transmit the crime severity ratings and/or the property safety rating to users and/or external systems.

### CROSS REFERENCE TO RELATED APPLICATIONS

This application is a non-provisional application which claims priority to U.S. Provisional Application No. 62/937,598 filed on Nov. 19, 2019, which is incorporated by reference in its entirety

### FIELD OF THE INVENTION

This invention relates to a framework, system, and method of assessing the safety of a property and its associated neighborhood, including a system that aggregates, standardizes, and transforms safety information from third party sources.

### BACKGROUND

Many steps must be taken when purchasing a home or other type of property. And while some of the steps are relatively straight forward and objective (e.g., reviewing the price, securing financing, etc.), other steps are currently more subjective, e.g., understanding the local market trends and associated property values, rating the local amenities, the school systems, the cultural values of the neighborhood, and the neighborhood's overall safety with respect to crime, etc.

There are many services available to help with the home buying process. For example, real estate brokers are available to assist potential buyers in finding available properties, in reviewing the pricing, and in understanding the market trends of the area. In addition, financial institutions are available to guide buyers through the financing process and to secure loans.

However, when it comes to determining the safety of the property and its associated neighborhood with respect to local crime rates, the services available are much more subjective, limited, and fragmented. For example, real estate brokers may provide opinions regarding their feelings towards the crime rates of a neighborhood, but these opinions may not be based on or even include specific information regarding the offenses committed, e.g., the exact types of offenses (violent vs. non-violent), the locations of the offenses (approximate or exact), the walking distances from the property address (approximate or exact), whether or not the perpetrators were apprehended, whether or not the perpetrators are still in custody, the residences of the perpetrators, and other types of specific information.

In fact, this information is not available from any one particular source, nor in any sort of standardized format. Instead, the information is only available from a multitude of disparate systems and sources, such as, without limitation, crime watchdog services, police records, news websites, local blogs, community websites, newspaper articles, research papers, etc. Given this, it can be seen that the information necessary to determine an objective crime safety rating for a particular real estate property must be aggregated from a variety of different sources, with each source providing the information in distinctly different non-standardized formats (e.g., a database vs. a newspaper article). Once the information is aggregated, the information must be parsed, and the non-standardized formats must be standardized so that the data may be processed and distributed cohesively.

Accordingly, there is a need for a service that aggregates relevant safety information pertaining to particular property addresses and their associated neighborhoods, that standardizes the format(s) of the safety information, that transforms the information into novel formats, and that presents the information to potential home buyers so that they may make objective decisions regarding the properties and their associated levels of safety. There also is a need for a system that transmits or otherwise shares the processed information to external third-party systems that may benefit from and/or apply the information in other applications.

### SUMMARY

According to one aspect, one or more embodiments are provided below for a computer-implemented method. The method may include receiving information regarding a physical address of a first real estate property from a first user, querying one or more external systems for information regarding crimes committed within a first radius of the physical address, receiving first information from a first of the one or more external systems regarding one or more first crimes committed within the first radius of the physical address, storing the first information into one or more databases, for each one of the one or more first crimes committed, determining a crime severity rating based at least in part on the first information, and processing the crime severity ratings to determine a first safety score associated with the first real estate property.

In another embodiment, the method further comprises displaying, on a client device associated with the first user, a map of the first radius including a property location indicator of the physical address and a crime scene indicator for each location of each of the one or more first crimes.

In another embodiment, the method further comprises displaying on the map the crime severity rating for each of the one or more first crimes, wherein the crime severity rating for each of the one or more first crimes is displayed adjacent the crime scene indicator of each of the one or more first crimes.

In another embodiment, the method further comprises displaying on the map the first safety score associated with the first real estate property, wherein the first safety score is displayed adjacent the property location indicator of the physical address.

In another embodiment, the method further comprises transmitting at least one crime severity rating determined to an external system.

In another embodiment, the method further comprises transmitting the first safety score determined to an external system.

In another embodiment, the method further comprises applying machine learning to the first data to determine a probability of a first future crime to be committed within the first radius within a future time period.

In another embodiment, the method further comprises receiving second information from a second of the one or more external systems regarding one or more second crimes committed within the first radius of the physical address, storing the second information into one or more databases, for each one of the one or more second crimes committed, determining a crime severity rating based at least in part on the second information, and processing the crime severity ratings to determine a second safety score associated with the first real property.

In another embodiment, the first information is received in a standardized format and the method further comprises receiving second information from a second of the one or more external systems regarding one or more second crimes committed within the first radius of the physical address, the second information received in a non-standardized format dependent on the hardware and/or software of the second of the one or more external systems, converting the non-standardized second information into the standardized format of the first information, storing the standardized second information into one or more databases, for each one of the one or more second crimes committed, determining a crime severity rating based at least in part on the standardized second information, and processing the crime severity ratings to determine a second safety score associated with the first real property.

According to another aspect, the present description includes a computer- implemented method comprising receiving information regarding a physical address of a first real estate property from a first user, querying one or more external systems for information regarding crimes committed within a first radius of the physical address, receiving first information in a standardized format from a first of the one or more external systems regarding one or more first crimes committed within the first radius of the physical address, storing the first information into one or more databases in a standardized format, receiving second information from a second of the one or more external systems regarding one or more second crimes committed within the first radius of the physical address, the second information received in a non-standardized format dependent on the hardware and/or software of the second of the one or more external systems, converting the non-standardized second information into the standardized format of the stored first information, for each one of the one or more first and second crimes committed, determining a crime severity rating based at least in part on the first information and/or the second information, and processing the crime severity ratings to determine a first safety score associated with the first real estate property.

In another embodiment, the method further comprises displaying, on a client device associated with the first user, the first safety score associated with the first real estate property.

In another embodiment, the method further comprises displaying, on a client device associated with the first user, a map of the first radius including a property location indicator of the physical address and a crime scene indicator for each location of each of the one or more first and second crimes.

In another embodiment, the method further comprises displaying on the map the crime severity rating for each of the one or more first and second crimes, wherein the crime severity rating for each of the one or more first and second crimes is displayed adjacent the crime scene indicator of each of the one or more first and second crimes.

In another embodiment, the method further comprises displaying on the map the first safety score associated with the first real estate property, wherein the first safety score is displayed adjacent the property location indicator of the physical address.

In another embodiment, the method further comprises transmitting at least one crime severity rating to an external system.

In another embodiment, the method further comprises transmitting the first safety score to an external system.

In another embodiment, the method further comprises applying machine learning to the first data and/or the second data to determine a probability of a first future crime to be committed within the first radius within a future time period.

According to another aspect, the present description includes a computer-implemented method comprising receiving information regarding a physical address of a first real estate property from a first user, querying one or more external systems for information regarding crimes committed within a first radius of the physical address, receiving first information in a standardized format from a first of the one or more external systems regarding one or more first crimes committed within the first radius of the physical address, storing the first information into one or more databases in a standardized format, receiving second information from a second of the one or more external systems regarding one or more second crimes committed within the first radius of the physical address, the second information received in a non-standardized format dependent on the hardware and/or software of the second of the one or more external systems, converting the non-standardized second information into the standardized format of the stored first information, storing the standardized second information into at least one database, for each one of the one or more first and second crimes committed, determining a crime severity rating based at least in part on the first information and/or the second information, processing the crime severity ratings to determine a first safety score associated with the first real estate property, and displaying, on a client device associated with the first user, a map of the first radius including a property location indicator of the physical address and a crime scene indicator for each location of each of the one or more first and second crimes.

In another embodiment, the method further comprises transmitting the first safety score to an external system.

In another embodiment, the method further comprises applying machine learning to the first data to determine a probability of a first future crime to be committed within the first radius within a future time period.

Other aspects and advantages of the invention will be apparent from the following description and the appended claims.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of a property safety assessment framework in accordance with exemplary embodiments hereof;

FIG. 2 shows aspects of a property safety assessment system in accordance with exemplary embodiments hereof;

FIG. 3 shows an example graphical safety data representation in accordance with exemplary embodiments hereof;

FIG. 4 shows an example graphical user interface dialog in accordance with exemplary embodiments hereof;

FIG. 5 shows an example graphical user interface dialog in accordance with exemplary embodiments hereof;

FIG. 6 shows an example graphical user interface dialog in accordance with exemplary embodiments hereof; and

FIG. 7 depicts aspects of computing and computer devices in accordance with exemplary embodiments hereof.

### DETAILED DESCRIPTION OF EXEMPLARY EMBODIMENTS

As used herein, unless used otherwise, the following terms and abbreviations have the following meanings:

API means application programming interface.

SDK means software development kit.

As used herein, the term “real property” (or “real estate property” or simply “property”) refers, without limitation, to any property that is attached to land, as well as the land itself. Real property not only includes buildings and other structures, but also rights and interests. Property and real property can be rental or residential or commercial. It should be appreciated that the system described herein is not limited in any way by the type or nature of the property.

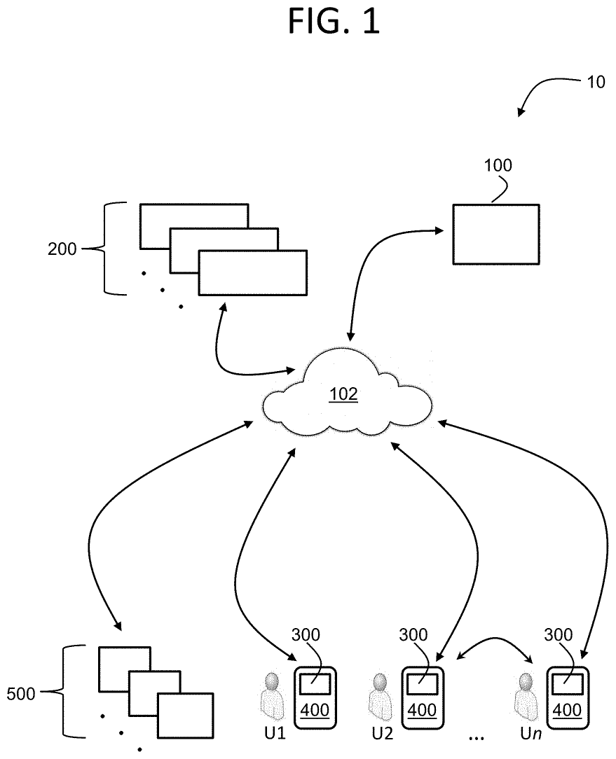

FIG. 1 shows an overview of an exemplary framework for a property and neighborhood safety assessment system 10 (also referred to as a property safety assessment system 10 or simply as a system 10) according to exemplary embodiments hereof. As shown, the property safety assessment system 10 may include a controller 100 that may interface with external systems 200 (e.g., local police record systems, court record systems, news sites, community watchdog sites, Crimometer™, Megan's Law site, Kids Live Safe site and other sources) to gather, collect and generally aggregate information. The interface may include a network 102 (e.g., the Internet, LAN, WAN, etc.), wireless communication systems, cellular communication systems, telephony or other types of communication systems or protocols.

In some embodiments, the controller 100 may include a cloud platform (e.g., one or more backend servers), one or more local controllers, or any combination thereof. In some embodiments, the controller 100 includes a cloud platform that interfaces with one or more local controllers. For example, administrators of the system 10 may interface with the system 10 via a local controller in communication to a cloud platform.

The system 10 also may be accessed by multiple users U1, U2, . . . Un (e.g., via the network 102) using an application 300 (e.g., a mobile application or “app”, a browser or other types of applications) running on one or more computing devices 400 (e.g., smart phones, tablet computers, laptops, desktop computers, mobile media players, etc.). The property safety assessment system 10 also may be accessible by various external systems 500 (e.g., real estate brokers, banks, services such as the Multiple Listing Service (MLS), external databases, and the like).

In general, and according to exemplary embodiments hereof, the property safety assessment system 10 may interface with and gather safety information from one or more third-party sources 200 regarding a particular property and its associated neighborhood, standardize the formats of the data, transform the data as will be described herein, and present the transformed data in various formats to its users Un and to various external systems. It may be preferable that the interaction between the system 10 and the third-party sources 200 be automated, however, in some cases manual intervention may be required. In this case, the system 10 may provide the tools necessary to facilitate the manual intervention.

As used herein, the term “safety information” may include information related to (without limitation): violent crimes committed, non-violent crimes committed, registered sex offenders, and other types of safety information. The safety information may include the type and/or category of the offense(s) committed, the location of the offense (exact and/or approximate), the distance of the offense from the location of the property (exact and/or approximate), the date and time of the offense(s), whether or not the perpetrators were apprehended (if available), whether or not the perpetrators are still in custody (if available), other information regarding the perpetrators (such as his/her prior record, release date if previously incarcerated and/or institutionalized, terms served, all if available, etc.), and other types of information. The safety information may be aggregated over specified time periods (e.g., over the past week, month, year, etc.).

In use, a user Un who may be interested in purchasing a family home in a particular neighborhood may utilize the system 10 to quantify the overall safety of the property and of the surrounding neighborhood. By entering the location of the property into the system 10 (e.g., the street address), the system 10 may gather the relevant safety information regarding the property and the surrounding neighborhood, standardize the format(s) of the information, transform the data into novel formats, and present the transformed data to the user Un for review. In this way, the user Un may be better-informed while deciding whether or not to purchase the property.

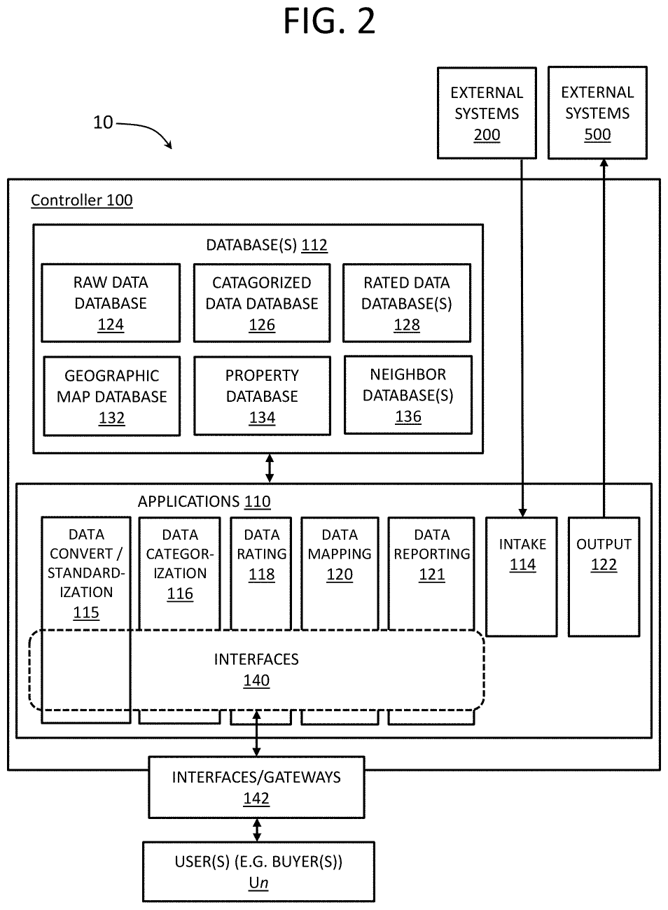

FIG. 2 shows aspects of an exemplary property safety assessment system 10 of FIG. 1. As shown in FIG. 2, the property safety assessment system 10 (sometimes referred to as the “backend”) comprises various applications 110 and one or more databases 112, described in greater detail below. The applications 110 may generally interact with the one or more databases 112.

The database(s) 112 may be or comprise one or more separate or integrated databases, at least some of which may be distributed. The database(s) 112 may be implemented in any manner, and, when made up of more than one database, the various databases need not all be implemented in the same way. It should be appreciated that the system is not limited by the nature or location of database(s) 112 or by the manner in which they are implemented.

Each of the applications 110 may provide one or more services via an appropriate interface. Although shown as separate applications 110 for the sake of this description, it is appreciated that some or all of the various applications 110 may be combined. The various applications 110 may be implemented in any manner and need not all be implemented in the same way (e.g., using the same software languages, interfaces or protocols).

The applications 110 may include one or more of the following applications 110:
1. Data intake application(s) 114
2. Data converting/standardization application(s) 115
2. Data categorization application(s) 116
3. Data rating application(s) 118
4. Data mapping application(s) 120
5. Data reporting application(s) 121
6. Data output application(s) 122

The applications 110 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

The database(s) 112 may include one or more of the following databases:
1. Raw data database(s) 124
2. Categorized data database(s) 126
3. Rated data database(s) 128
4. Geographic map database(s) 132
5. Property database(s) 134
6. Neighbor database(s) 136

It is understood that the above list of databases is meant for demonstration and that the system 10 may include some or all of the databases, and also may include additional databases as required. It is also understood that the scope of the system 10 is not limited in any way by the databases that is may include.

Various applications 110 in the property safety assessment system 10 may be accessible via interface(s) 140. These interfaces 140 may be provided in the form of APIs or the like, made accessible to external users Un via one or more gateways and interfaces 142 (e.g., via a web-based application and/or an application running on a user's device).

In some exemplary embodiments hereof, the system 10 communicates with external systems 200 (e.g., local police record systems, news sites, community watchdog sites, Megan's Law site, Kids Live Safe site, Crimometer™, and other sources) to update, gather, collect, aggregate and store property safety information for use with its applications 110. In some embodiments, the external systems 200 may contain safety information pertaining to specific localized geographic areas (e.g., specific cities, towns, states, zip codes, etc.) such that the system 10 may interface with different external systems 200 to collect information for different locations. In other embodiments, the system 10 may interface with external systems 200 that include safety information pertaining to much larger geographic spans (e.g., national databases that include information for an entire country). In other embodiments, the system 10 communicates with both localized and non-localized (e.g., national) external systems 200 simultaneously, sequentially and/or generally as needed.

In some embodiments, the system 10 may be programmed to interact with a wide variety of different external systems 200, and because the system 10 may or may not be linked to external systems 200 for each and every geographic location of interest, the system 10 may offer services for specific areas (e.g., specific cities, towns, states, zip codes, etc.). In some embodiments, it may be preferable that the system 10 notify its users regarding what geographic areas may or may not be supported.

In some embodiments, the system 10, via its data intake application 114, may be programmed to update (synchronize) with the external systems 200 at scheduled intervals (e.g., every day at midnight) so that its stored information is sufficiently up-to-date. The data intake application 114 may be programmed (via various APIs, SDKs, other communication protocols, etc.) to interface and retrieve safety information from each external source 200 at a scheduled day and time, and to save the raw safety data into the raw data database 124.

In some embodiments, the system 10 may be triggered (e.g., in real time) to interface with different external systems 200 and to update the safety information at non-scheduled times. In some embodiments, this non-scheduled triggering may be performed automatically. The update may be triggered automatically by the system 10 or by an external system(s) 200. For example, the system 10 may learn that a new update is available that is deemed urgent and may consequently interface with the external systems 200 and receive the updated safety information. In other embodiments, an external system 200 may trigger an update when the external system 200 receives new crime information that meets predefined criteria (e.g., a crime of high severity), thereby flagging the system 10 that an update is required. When the external system 200 receives the new information and the criteria is met, the external system 200 may initiate the interfacing and the providing of the updated information to the system 10.

In some embodiments, if an automatic synchronization between the system 10 and one or more particular external systems 200 is not available, the system 10 may be manually triggered to update its safety information by an administrator or user of the system 10, and/or by an administrator or user of an external system(s) 200. This may occur, for example, if the system 10 is not able to automatically interface with a particular external system 200. In another example, this may occur when an external system 200 may receive new crime information that is perceived as urgent for the system 10 to immediately receive (e.g., “breaking news”) but that may not necessarily trigger an automated update. In this case, an administrator or user of either system 10, 200 may log into the system 10 and manually initiate the interfacing and the updating of the safety information to the system 10.

In some embodiments, the system 10 may facilitate the manual triggering and/or updating of the safety information by providing easy access to the external source(s) 200 (e.g., a library of links and/or other types of interfaces), a dialogue to enter the safety information into the system 10, wizards to guide the administrator through the process, and other tools and/or applications as required. In this way, the system 10 may automatically intake data that it can and guide an administrator to help facilitate the intake of any additional data, as necessary.

The raw safety information may preferably include the types of offenses committed, the location of the offenses (approximate and/or exact), the date of the offenses, whether or not the perpetrators were apprehended (if available), whether or not the perpetrators are still in custody (if available), the prior record of the perpetrators (if available), the release date of the perpetrators if previously incarcerated and/or institutionalized (if available), terms served (if available), etc., and other pertinent types of information.

It can be appreciated that in some cases the external systems 200 may provide the safety information to the system 10 in standardized data formats. In this way, the information may be parsed or otherwise read and extracted by the system 10 using standardized parsing techniques (e.g., comma delimited, space delimited, etc.). The information, and data points such as time, location, type of crime, etc. may be parsed using the standardized methodologies for the types of data formats provided.

However, in other cases, the data may be provided in non-standardized data formats. In one example of this, the data may be provided in sentence and/or paragraph form such as in written newspaper articles, blog posts, or research papers. In this case, the system 10 may include smart algorithms (e.g., artificial intelligence (AI) via machine learning, deep neural networks, etc.) to parse, read, understand or otherwise capture the data points of interest from the non-standardized data formats and convert or otherwise transform the data points into a standardized format that may then be processed and shared by the system 10. In another example, the updated data may be provided in non-standardized formats that are dependent on the hardware and/or software platform(s) used by the external systems 200 and/or by the administrators and/or users of the systems 200. In any event, it is understood that updated safety information provided to the system 10 in a non-standardized format may be converted into a standardized format by the system 10. In some embodiments, this may be performed by the system's data converting/standardization application 115.

The standardized updated safety information (whether received in a standardized format or converted into a standardized format) may next be stored into a database, such as the raw data database 124. Once the raw data is standardized and is stored in the raw data database 124, the data categorization application 116 may process the information to classify the data of interest. For example, the categorization application 116 may group the data by type (e.g., by geographic location, type of crime committed, time/date of the crime, and other types of types) and store the categorized data into the categorized data database 126.

In some embodiments, the system 10 may use the data rating application 118 to rate the categorized safety data using a variety of criteria. For example, the categorized data may be rated by the type and severity of the crime committed, with violent crimes such as murder, assault and battery, armed robbery, etc. rated higher than non-violent crimes such as shop lifting, theft and drug related offenses. In this way, the severity of the crimes may be rated and classified as a crime severity rating. In another example, the data may be rated according to the perpetrators, with repeat offenders being rated higher than first-time offenders. In another example, the data may be rated by amount of time that has passed since the crime(s) were committed, the amount of time between each crime committed, and/or the frequency or patterns of the crimes committed. Other types of rating criteria also may be used. In this way, each crime may be given one or more scores that may represent the severity of the crime committed. Once the scores have been calculated, the scores and the rated data may be stored in the rated data database 128.

In addition, in some embodiments, the data rating application 118 may calculate one or more overall safety ratings for each property of interest by applying weight factors and/or algorithms to each type of safety data associated with the property. For example, a property located near the locations of identified violent crimes may receive a lower overall safety score compared to a property associated with a lesser number or less severe crimes within the same or similar geographic radius and/or time frame. In this way, the property's overall safety rating may generally represent a quality of life aspect associated with the property.

In some embodiments, the categorized safety data is used to forecast the likelihood of potential future threats of violence or other types of crimes within a predetermined radius of the property of interest. The system 10 may utilize machine learning to identify safety trends within the area and to predict the probabilities that one or more particular types of crimes may be committed within the area and within a particular future time period.

In some embodiments, the geographic map database 132 may include maps of each geographical area that the system 10 may support, with the maps including street address and other types of identifying information for each property included within the geographic regions. Then, when an address is provided by the user (as described in other sections), the data mapping application 120 may locate the property on a corresponding geographical map (e.g., stored in the geographical map database 132). In addition, the data mapping application 120 also may pull applicable data from the categorized data database 126 and/or the rated data database 128 (e.g., the location of recorded offenses) and correlate the location of the offenses on the geographical map associated with the property of interest. In this way, the system 10 may geographically present the safety data by location and severity with respect to each property.

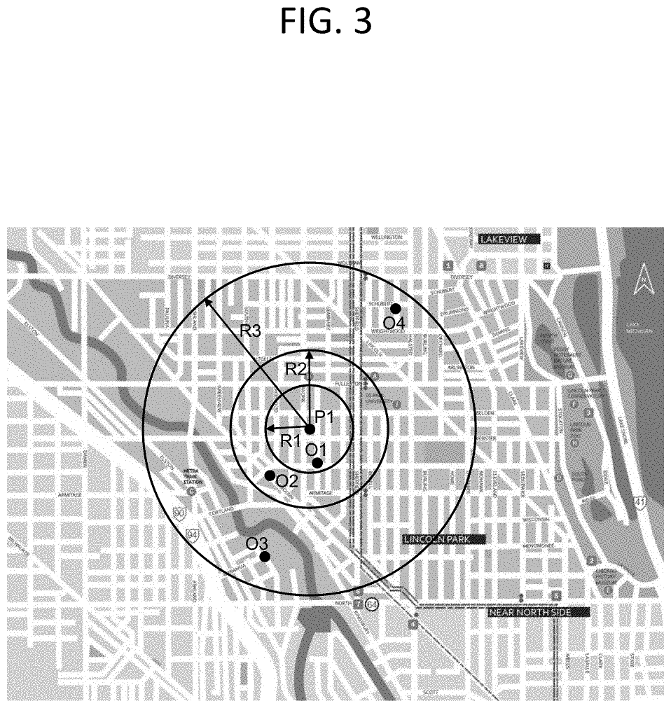

In some embodiments, the data mapping application 120 may place one or more radiuses around the property of interest (e.g., radiuses of 0.1 miles, 0.2 miles, 0.3 miles, 0.4 miles, 0.5 miles, 1.0 miles, and so on), and represent each applicable offense within each radius. In one embodiment, the representation may include a graphical geographic presentation (e.g., a map) of the area surrounding the property as shown in FIG. 3. In this example, the system 10 has placed three radiuses R1, R2, R3 around the property's address (e.g., at 0.1 miles, 0.2 miles and 0.5 miles), and the applicable offenses O1, O2, O3, O4 at each of the offense's respective locations within the radiuses R1, R2, R3.

In some embodiments, the map may be interactive (e.g., provided via the mobile application 300, website or similar) and the user Un may click on the graphical location(s) of the offenses On to receive further information regarding each chosen offense On. For example, the user may click on offense O1 and the map may expand a dialogue box to display additional information regarding the offense O1, such as (without limitation) the offense committed, the location of the offense O1 (exact and/or approximate), the date and time of the offense, the distance from the offense to the property (exact and/or approximate), the category of the offense, the rating of the offense, whether or not the perpetrators were apprehended, whether or not the perpetrators are still in custody, and any other types of safety information. In some embodiments, the offenses On may represent the residences of registered sexual offenders or other types of offenders.

In some embodiments the displayed information may be color-coded. For example, the information may be color-coded according to the severity of the offenses committed, with more severe offenses colored in red and lesser severe offenses colored in yellow or orange. In another example, the areas within each radius may be color-coded (e.g., shaded) to display whether or not severe offenses were committed in each of the areas, with green areas being free of severe offenses and red areas containing severe offenses. It is understood that any type and/or combinations of types of color-coding(s) may be applied (e.g., gradients, sectional, etc.) to visually represent the offenses On, and that the scope of the system 10 is not limited by the types of color-coding used.

In some embodiments, the system 10 may create and provide various reports to the user(s) Un via the data reporting application 121. The reports may include the time period over which the safety information has been aggregated, and textual data describing the safety data for each applicable offense On, the safety ratings(s) (scores) of the property and its surrounding neighborhood, charts that graphically display the safety data and the ratings (e.g., bar charts, pie charts, etc.), maps, any other types of data representations and any combinations thereof. In some embodiments, safety data and/or ratings contained in the report(s) may be color-coded as described above (with respect to FIG. 3) to provide a visual representation of the data. In some embodiments this data may be referred to as a traffic light checklist.

In some embodiments, the system 10 may intake background information relating to the residents of the neighboring properties adjacent to or in close proximity to the property of interest. For example, the system 10 may intake information such as criminal records, sex offences and other types of information. This information may then be provided to the user Un via the reports and/or maps as described in other sections.

In some embodiments, any of the reports and/or graphical representations of the data may be provided as virtual reports (e.g., via the mobile application 300 or such), hard copy reports and/or any combination thereof.

In some embodiments, the system 10 may store into its property database 134 identifying information (e.g., street addresses) regarding each property submitted, and may link this information to the property's associated information within the other databases. In this way, the system 10 may identify properties that may have been submitted prior and may include historical data for these properties and their associated neighborhoods. Using this historical data, the system 10 may calculate trends associated with the property (e.g., whether the crime rate is improving or getting worse), market demand and other types of home buying trends. The system 10 may run reports regarding the different properties, the associated crime rate trends, market demands, market trends and other types of computed information, and may provide the information to external systems 500 (e.g., real estate brokers, banks, services such as the Multiple Listing Service (MLS), external databases, and the like).

### In Use

For the purposes of this specification, additional functionalities of the system 10, the applications 110 and the databases 112 will be described by way of various examples depicting how the system 10 may be used by a user Un to assess the safety of a particular property and its associated neighborhood. It is understood that the examples described are meant for demonstrational purposes and may not represent the exact steps that the system 10 may take, nor are the representations of the steps all-inclusive of the steps that the system 10 may take while performing its functionalities. A person of ordinary skill in the art will understand, upon reading this specification, that the steps shown may be performed in any order, that not all of the steps may be performed, and that other steps not shown also may be performed as required according to the exemplary embodiments of the system 10 hereof.

As an option, the system 10 may require a user Un to create an account with the system 10 in order to utilize its services, and upon such an account creation, the user Un may receive credentials (e.g., username and password) that may provide the user Un access to the system 10. The registration process may or may not require a fee.

In a first step of use, a user Un may log into the system 10 (e.g., via an application 300 such as a mobile app, website or similar) and input a street address (or other type(s) of identifying information) of the property of interest. The system 10 may receive the address and store it in the property database 134 in a file associated with the user's account. The user Un may also specify the time period over which the safety data should span (e.g., data relating to the past week, month, year, etc.). In some embodiments, the system 10 may provide a default time period (e.g., over the past month).

Upon receiving the address of the property, the system 10 may check its various databases 112 to ascertain whether or not the geographic location of the address is supported by the system 10. If it is, the system 10 may proceed as described in this specification. If the address is not supported by the system 10, the system 10 may communicate this to the user Un along with information on how the user Un may submit a request for future support for the property. In this case, and if possible, the system 10 may be updated by its management to incorporate the requested geographic area.

If the address is supported, the system 10 may check its various databases to ascertain whether or not it has stored recently sufficient safety information for the address, and if so, may present the safety data to the user Un (as described in other sections).

If the system 10 ascertains that it does not include recently sufficient safety information for the address, the system 10 may query the external sources 200 and intake up-to-date safety information via the uptake application 114. The system 10 may then perform all or some of the following steps: (i) convert any non-standardized update information into a standardized format, (ii) store the data in its raw data database 124, (iii) process the raw data using the data categorization application 116 and store the categorized data into the categorized data database 126, (iv) process the data using the data rating application 118 and store the rated data into the rated data database 128, and (v) map the data using the data mapping application 120 and store the mapped data into the geographic map database 132.

Once the safety data has been processed, the system 10 (via the data reporting application 121) may provide safety and rating report(s), interactive map(s) (FIG. 3) and/or other formats of safety data as described herein.

In some embodiments, the system 10 may provide tiers of services provided, such that users Un may choose (and pay for) only the services they may desire. For example, one tier may provide the interactive map but not an associated comprehensive report regarding the property. In another example, a second tier may include both the map and the comprehensive report, and a third tier may include the map, the comprehensive report and background checks of the residents adjacent to the property. It is understood that the system 10 may provide any number and/or type of service tiers and that the scope of the system 10 is not limited in any way by the tiers of service that it may provide.

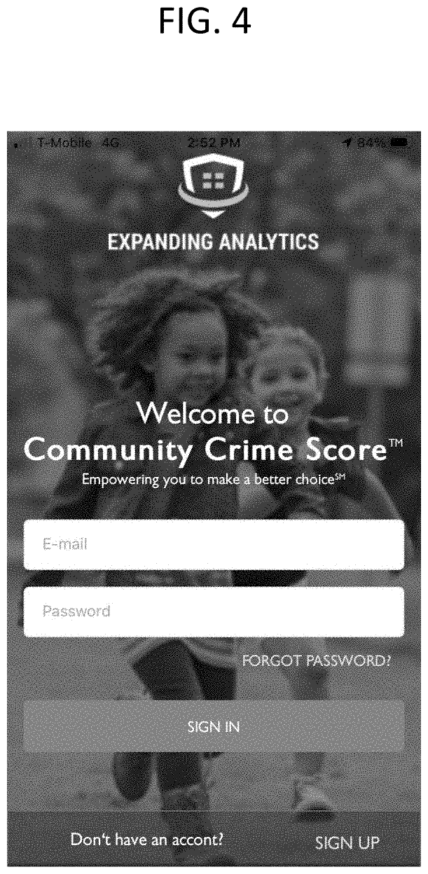

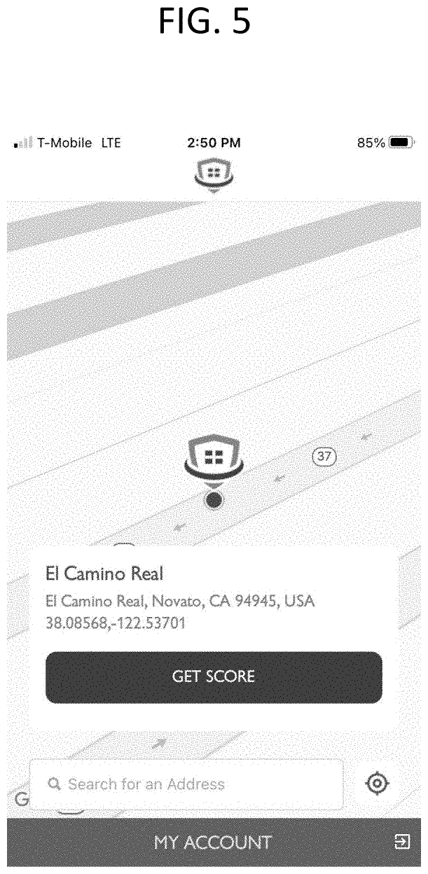

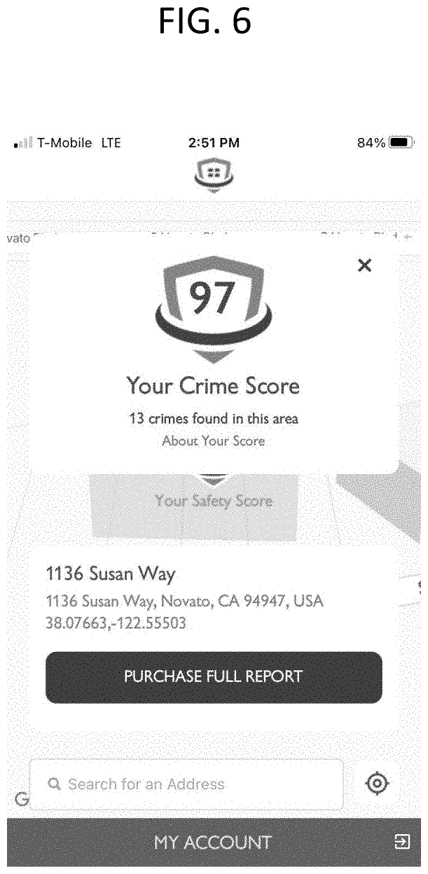

FIGS. 4-6 show example screenshots of various dialogs that may be presented to a user of the system 10 via the system's GUI during use. For example, FIG. 4 shows an example log-in page where a user may enter his/her username and password to enter the application 300. In another example, FIG. 5 shows an example “search for an address” page where a user may enter a particular physical street address for the system to find and process as described in other section. FIG. 6 shows an example results page that shows a resulting crime score and associated information (e.g., number of crimes committed within a radius of the address over a specific period of time) for the property in question. It is understood that these example screenshots are meant for demonstration and that the dialogs depicted do not limit the scope of the system 10 in any way.

### Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

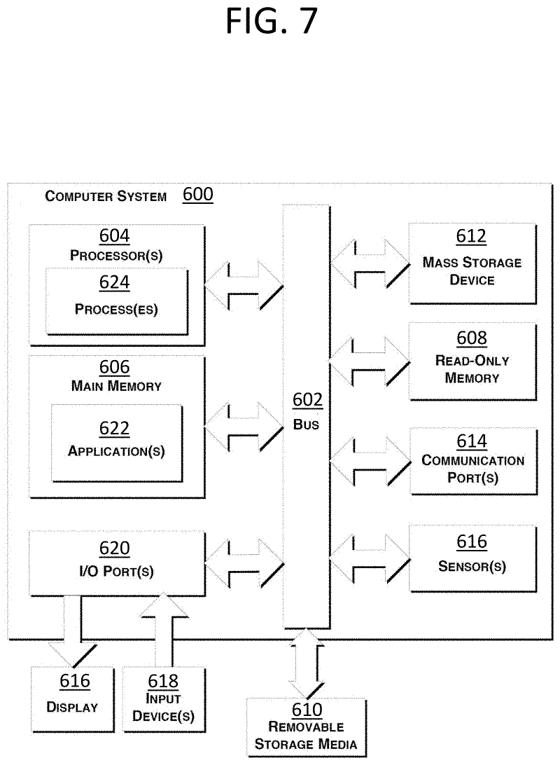

FIG. 7 is a schematic diagram of a computer system 600 upon which embodiments of the present disclosure may be implemented and carried out.

According to the present example, the computer system 600 includes a bus 602 (i.e., interconnect), one or more processors 604, one or more communications ports 614, a main memory 606, removable storage media 610, read-only memory 608, and a mass storage 612. Communication port(s) 614 may be connected to one or more networks by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an RS-232 port for use with a modem-based dial-up connection, a 10/100 Ethernet port, a Gigabit port using copper or fiber, or a USB port, and the like. Communications port(s) 614 may be chosen depending on a network such as a Local Area Network (LAN), a Wide Area Network (WAN), a CDN, or any network to which the computer system 600 connects. The computer system 600 may be in communication with peripheral devices (e.g., display screen 616, input device(s) 618) via Input/Output (I/O) port 620. Some or all of the peripheral devices may be integrated into the computer system 600, and the input device(s) 618 may be integrated into the display screen 616 (e.g., in the case of a touch screen).

Main memory 606 can be Random Access Memory (RAM), or any other dynamic storage device(s) commonly known in the art. Read-only memory 608 can be any static storage device(s) such as Programmable Read-Only Memory (PROM) chips for storing static information such as instructions for processor(s) 604. Mass storage 612 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 602 communicatively couples processor(s) 604 with the other memory, storage and communications blocks. Bus 602 can be a PCI/PCI-X, SCSI, a Universal Serial Bus (USB) based system bus (or other) depending on the storage devices used, and the like. Removable storage media 610 can be any kind of external hard-drives, floppy drives, IOMEGA® Zip Drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMS, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 606 is encoded with application(s) 622 that support(s) the functionality as discussed herein (an application 622 may be an application that provides some or all of the functionality of one or more of the mechanisms described herein). Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service(s) or mechanism(s) related to the application(s). In other words, the process(es) 624 represents one or more portions of the application(s) 622 performing within or upon the processor(s) 604 in the computer system 600.

It should be noted that, in addition to the process(es) 624 that carries(carry) out operations as discussed herein, other embodiments herein include the application 622 itself (i.e., the un-executed or non-performing logic instructions and/or data). The application 622 may be stored on a computer readable medium (e.g., a repository) such as a disk or in an optical medium. According to other embodiments, the application 622 can also be stored in a memory type system such as in firmware, read only memory (ROM), or, as in this example, as executable code within the main memory 606 (e.g., within Random Access Memory or RAM). For example, application 622 may also be stored in removable storage media 610, read-only memory 608, and/or mass storage device 612.

Those skilled in the art will understand that the computer system 600 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer-implemented method comprising:
(A) by one or more computer systems, receiving information regarding a physical address of a first real estate property from a first user;
(B) by one or more computer systems, querying one or more external systems for information regarding crimes committed within a first radius of the physical address;
(C) by one or more computer systems, receiving first information from a first of the one or more external systems regarding one or more first crimes committed within the first radius of the physical address;
(D) by one or more computer systems, storing the first information into one or more databases;
(E) by one or more computer systems, for each one of the one or more first crimes committed, determining a crime severity rating based at least in part on the first information; and
(F) by one or more computer systems, processing the crime severity ratings determined in (E) to determine a first safety score associated with the first real estate property.

2. The computer-implemented method of claim 1 further comprising:
(G) by one or more computer systems, displaying, on a client device associated with the first user, a map of the first radius including a property location indicator of the physical address and a crime scene indicator for each location of each of the one or more first crimes rated in (E).

3. The computer-implemented method of claim 2 further comprising:
(H) by one or more computer systems, displaying on the map the crime severity rating determined in (E) for each of the one or more first crimes;
wherein the crime severity rating for each of the one or more first crimes is displayed adjacent the crime scene indicator of each of the one or more first crimes.

4. The computer-implemented method of claim 2 further comprising:
(H) by one or more computer systems, displaying on the map the first safety score associated with the first real estate property;
wherein the first safety score is displayed adjacent the property location indicator of the physical address.

5. The computer-implemented method of claim 1 further comprising:
(G) by one or more computer systems, transmitting at least one crime severity rating determined in (E) to an external system.

6. The computer-implemented method of claim 1 further comprising:
(G) by one or more computer systems, transmitting the first safety score determined in (F) to an external system.

7. The computer-implemented method of claim 1 further comprising:
(G) by one or more computer systems, applying machine learning to the first information to determine a probability of a first future crime to be committed within the first radius within a future time period.

8. The computer-implemented method of claim 1 further comprising:
(G) by one or more computer systems, receiving second information from a second of the one or more external systems regarding one or more second crimes committed within the first radius of the physical address;
(H) by one or more computer systems, storing the second information into one or more databases;
(I) by one or more computer systems, for each one of the one or more second crimes committed, determining a crime severity rating based at least in part on the second information; and
(J) by one or more computer systems, processing the crime severity ratings determined in (E) and (I) to determine a second safety score associated with the first real property.

9. The computer-implemented method of claim 1 wherein the first information is received in (C) in a standardized format, the method further comprising:
(G) by one or more computer systems, receiving second information from a second of the one or more external systems regarding one or more second crimes committed within the first radius of the physical address, the second information received in a non-standardized format dependent on the hardware and/or software of the second of the one or more external systems;
(H) by one or more computer systems, converting the non-standardized second information into the standardized format of the first information;
(I) by one or more computer systems, storing the standardized second information into one or more databases;
(J) by one or more computer systems, for each one of the one or more second crimes committed, determining a crime severity rating based at least in part on the standardized second information; and
(K) by one or more computer systems, processing the crime severity ratings determined in (E) and (J) to determine a second safety score associated with the first real property.

10. A computer-implemented method comprising:
(A) by one or more computer systems, receiving information regarding a physical address of a first real estate property from a first user;
(B) by one or more computer systems, querying one or more external systems for information regarding crimes committed within a first radius of the physical address;
(C) by one or more computer systems, receiving first information in a standardized format from a first of the one or more external systems regarding one or more first crimes committed within the first radius of the physical address;
(D) by one or more computer systems, storing the first information into one or more databases in a standardized format;
(E) by one or more computer systems, receiving second information from a second of the one or more external systems regarding one or more second crimes committed within the first radius of the physical address, the second information received in a non-standardized format dependent on the hardware and/or software of the second of the one or more external systems;
(F) by one or more computer systems, converting the non-standardized second information into the standardized format of the stored first information;
(G) by one or more computer systems, for each one of the one or more first and second crimes committed, determining a crime severity rating based at least in part on the first information and/or the second information; and
(H) by one or more computer systems, processing the crime severity ratings determined in (G) to determine a first safety score associated with the first real estate property.

11. The computer-implemented method of claim 10 further comprising:
(I) by one or more computer systems, displaying, on a client device associated with the first user, the first safety score associated with the first real estate property as determined in (H).

12. The computer-implemented method of claim 10 further comprising:
(I) by one or more computer systems, displaying, on a client device associated with the first user, a map of the first radius including a property location indicator of the physical address and a crime scene indicator for each location of each of the one or more first and second crimes rated in (G).

13. The computer-implemented method of claim 12 further comprising:
(J) by one or more computer systems, displaying on the map the crime severity rating determined in (G) for each of the one or more first and second crimes;
wherein the crime severity rating for each of the one or more first and second crimes is displayed adjacent the crime scene indicator of each of the one or more first and second crimes.

14. The computer-implemented method of claim 12 further comprising:
(J) by one or more computer systems, displaying on the map the first safety score associated with the first real estate property;
wherein the first safety score is displayed adjacent the property location indicator of the physical address.

15. The computer-implemented method of claim 10 further comprising:
(I) by one or more computer systems, transmitting at least one crime severity rating determined in (G) to an external system.

16. The computer-implemented method of claim 10 further comprising:
(I) by one or more computer systems, transmitting the first safety score determined in (H) to an external system.

17. The computer-implemented method of claim 10 further comprising:
(I) by one or more computer systems, applying machine learning to the first information and/or the second information to determine a probability of a first future crime to be committed within the first radius within a future time period.

18. A computer-implemented method comprising:
(A) by one or more computer systems, receiving information regarding a physical address of a first real estate property from a first user;
(B) by one or more computer systems, querying one or more external systems for information regarding crimes committed within a first radius of the physical address;
(C) by one or more computer systems, receiving first information in a standardized format from a first of the one or more external systems regarding one or more first crimes committed within the first radius of the physical address;
(D) by one or more computer systems, storing the first information into one or more databases in a standardized format;
(E) by one or more computer systems, receiving second information from a second of the one or more external systems regarding one or more second crimes committed within the first radius of the physical address, the second information received in a non-standardized format dependent on the hardware and/or software of the second of the one or more external systems;
(F) by one or more computer systems, converting the non-standardized second information into the standardized format of the stored first information;
(G) by one or more computer systems, storing the standardized second information into at least one database;
(H) by one or more computer systems, for each one of the one or more first and second crimes committed, determining a crime severity rating based at least in part on the first information and/or the second information;
(I) by one or more computer systems, processing the crime severity ratings determined in (G) to determine a first safety score associated with the first real estate property; and
(J) by one or more computer systems, displaying, on a client device associated with the first user, a map of the first radius including a property location indicator of the physical address and a crime scene indicator for each location of each of the one or more first and second crimes rated in (H).

19. The computer-implemented method of claim 18 further comprising:
(K) by one or more computer systems, transmitting the first safety score determined in (I) to an external system.

20. The computer-implemented method of claim 18 further comprising:
(K) by one or more computer systems, applying machine learning to the first information to determine a probability of a first future crime to be committed within the first radius within a future time period.
